(19) United States
(12) Patent Application Publication
(10) Pub. No.: US 2003/0228208 A1
(43) Pub. Date: Dec. 11, 2003

(54) Vertical conveyor and vertical conveyor system

(76) Inventor: Johann W. Grond, Emden (DE)

Correspondence Address: COLLARD & ROE, P.C., 1077 Northern Boulevard, Roslyn, NY, 11576-1696, US

(21) Appl. No.: 10/420,370

(22) Filed: Apr. 22, 2003

Related U.S. Application Data
(63) Continuation-in-part of application No. 09/865,270, filed on May 25, 2001, now abandoned.

(30) Foreign Application Priority Data
May 25, 2000 (DE) 100 26 346.1

(51) Int. Cl. B65G 1/00

(52) U.S. Cl. 414/267; 414/277

(57) ABSTRACT

A vertical conveyor for transporting a load in a warehouse equipped with shelves. This vertical conveyor comprises a plurality of receiving devices spaced apart from one another. These receiving devices receive a load and can be displaced vertically. There are also a series of stationary transport elements disposed adjacent to the plurality of receiving devices in an alternating manner. The plurality of receiving devices can comprise driven rollers while the series of stationary transport elements can also comprise driven rollers. There is also a vertical conveyor system that includes a plurality of vertically extending columns defining a shaft. The vertical conveyor can move vertically in this shaft. The vertically extending columns have at least one foldable element coupled to it wherein the foldable element is designed to fold down to allow the vertical conveyor to travel in the shaft and to fold up to remove a load from the vertical conveyor.

### CROSS REFERENCE TO RELATED APPLICATIONS

This application is a continuation in part application of U.S. patent application Ser. No. 09/865,270 filed on May 25, 2001 and priority is claimed under 35 U.S.C. §120 wherein the application is incorporated herein by reference and which is based upon German Application DE 10026346.1 filed on May 25, 2000 wherein priority is claimed under 35 U.S.C. §119.

### BACKGROUND OF THE INVENTION

1. Field of the Invention

The invention relates to a vertical conveyor for transporting a load in a warehouse equipped with stocking shelves.

2. The Prior Art

Such shelf warehouses have been served until now with the help of forklift trucks and/or floor conveyor devices that can be operated partly by hand and partly in an automated manner. It is necessary in conjunction with such stock-keeping systems to have a transporting device that always moves together with the load to be transported wherein the transporting device has a high dead weight. This requires a relatively high energy expenditure and the can also possibly restrict the speed.

To automate such a warehouse facility to a high degree it is particularly necessary to install a vertical conveyor that largely operates in an automatic manner.

### SUMMARY OF THE INVENTION

Therefore, the invention is based on the problem of providing a vertical conveyor of the type specified above that can be used in an automatically operated shelf-equipped warehouse. This problem is solved with a vertical conveyor having a plurality of receiving devices spaced apart from one another, wherein these receiving devices receive a load and wherein these receiving devices can be displaced vertically.

The transfer of a load is possible and particularly easy with this type of a vertical conveyor because loads can be transferred with the help of additional elements in the form of rollers or stationary transport elements which help to easily transport these loads. These additional elements are arranged between these spaced-apart receiving devices. The overall purpose of such receiving devices is to safely support loads that are preferably arranged in two parallel rows, on which the overall load rests in a safe manner. The transported loads may be collies, pallets or other forms of loads. The loads are favorably positioned on a transport pallet.

According to a preferred advanced development of the invention, the receiving devices are driven so that the load can be transported in the horizontal direction. It is particularly possible to simply transport a load into the vertical conveyor and to then to remove it from the conveyor. A plurality of revolving belts can be used to connect the individual receiving devices with each other and to assure that the load resting on the receiving devices is uniformly advanced.

According to another advanced development of the invention, the vertical conveyor has transport elements that are disposed in a stationary manner at least at one level. This level is preferably the basic level or the floor on which the loads are delivered to the shelf warehouse and loaded on the vertical conveyor. Thus, when these stationary transport elements are used, it is possible to transport loads also on the basic bottom level or some other level if the vertical conveyor is not positioned at that level. In this way, the vertical conveyor can transport a load to the top level (or tier) of the shelf warehouse, on the one hand, and alternatively the loads can be further transported at the same time to rows located in the rear at the basic level. The stationary transport elements are preferably arranged spaced from each other as well, so that other elements and in particular, the receiving devices can be placed between these stationary transport elements. It is particularly preferred that the receiving devices and the transport elements are arranged in an alternating manner, so that a nearly through-extending surface is formed at the moment the vertical conveyor is located at the level of the transport elements.

Furthermore, it is favorable if the receiving devices can be lowered to slightly below the level of the transport elements. Thus, it is possible to push a load onto the transport elements without causing the receiving devices to interfere with the movement of the movable part of the vertical conveyor. When the vertically movable part of the vertical conveyor is in this lowered position, it can be maintained there in an idle (or resting) position without interfering with the horizontal movement taking place above at the basic level where the loads are delivered to the individual rows of shelves.

According to a preferred embodiment of the invention, the receiving devices are substantially formed by driven rollers. The transport elements are favorably designed in the form of rollers as well, so that a through-extending row of rollers is formed within the range of the vertical conveyor, wherein these rollers are arranged so that each stationary roller is alternating with a roller that can be driven up together with the vertical conveyor. Other embodiments of the receiving devices and transport elements can be basically realized as well. For example, these devices and elements may be formed as conveyor belts or sliding elements.

The vertical conveyor is preferably arranged in the shelf warehouse in a row of shelves, so that the load is loaded on the vertical conveyor, and conveyed in the vertical conveyor upwards, and then comes to rest in an upper row of shelves parallel with a shelf compartment, so that an automatic load removal system accesses the vertical conveyor in the same way as all other shelf compartments present in that row next to it. Therefore, the vertical conveyor is not arranged in the runway between two rows of shelves, but rather in a row of shelves, preferably at one end of a row of shelves. However, it is conceivable also that the row of shelves is extended on both sides of the vertical conveyor.

According to yet another advanced development of the invention, the receiving devices are designed so that they can be folded away, so that such devices will not reach up to their actual transport position but can be folded up or down without interfering with a load passing through. It is conceivable also that the receiving devices can be retracted or pulled away sideways.

According to another preferred advanced development of the invention, each level of the vertical conveyor can have a roller track that can be folded down, whereby this roller track corresponds with the transport elements of the lower level. When a load is then steered to a certain level, the vertical conveyor can be driven first into a position slightly above such a defined level without requiring any entirely exact and complicated positioning of the conveyor. As soon as the load has reached the desired area, the folded-down transport elements forming a roller track are folded up and the vertical conveyor is then driven down and deposits the load on the transport elements. The warehouse stocking operation can be further accelerated in this manner.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 is a cut top view of the basic level of a warehouse equipped with stocking shelves;

FIG. 2 is a top view of a vertical conveyor as defined by the invention;

FIG. 3 is a cut side view of a vertical conveyor as defined by the invention;

FIG. 4 is a cut side view of a vertical conveyor as defined by the invention, shown with a lifted load;

FIG. 5 is a cut side view of a vertical conveyor as defined by the invention shown in another operating position;

FIG. 6a shows another embodiment of the invention having a foldable element in a down position;

FIG. 6b shows another embodiment showing the foldable element folded up;

FIG. 7 shows the embodiment of FIG. 6a with the vertical conveyor moving into position;

FIG. 8 shows a second embodiment of the device of FIG. 6a with the foldable element folded up in an activated position;

FIG. 9 shows a third embodiment of the device of FIG. 6a with a slidable element;

FIG. 10 is a top view of the device of FIG. 6a showing the shaft housing the foldable element in a down position; and

FIG. 11 is a side view of another embodiment of the invention which shows a plurality of slidable elements.

### DETAILED DESCRIPTION OF PREFERRED EMBODIMENTS

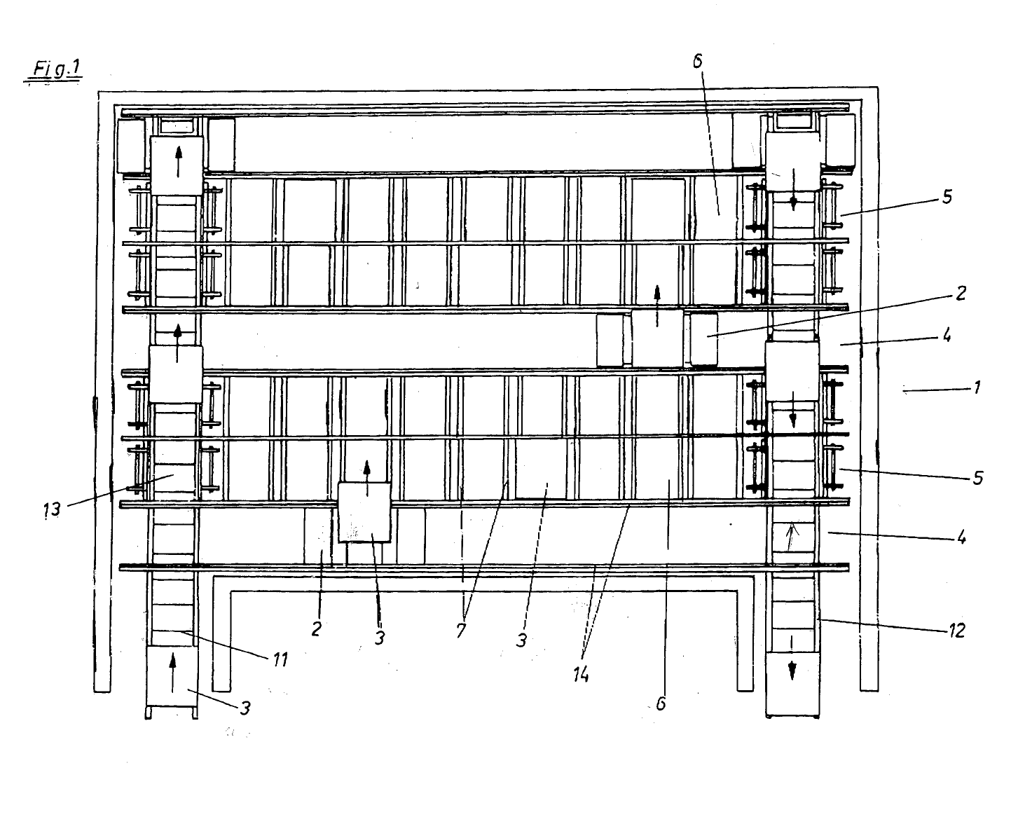

FIG. 1 is a top view of the basic level of a shelf warehouse 1, where loads are stocked in and removed from shelf locations 6 or shelf compartments. In such a stockkeeping operation, loads 3 are transported on a stocking track 11 and delivered into shelf warehouse 1 and transported out of the shelf warehouse on a load removal track 12. Shelf warehouse 1 comprises shelf runways 4 and rows 5 of shelves. Loads 3 are first transported on stocking track 11 to vertical conveyors 13 located at the ends of shelf rows 5 and then raised with vertical conveyors 13 to the desired level of the shelf warehouse. At this level, the loads are removed from vertical conveyor 13 with transport devices 2 running on rails 14 along shelf runway 4. Loads 3 are removed from vertical conveyor 13, transported along self runway 4, on rollers 7 and then delivered to the desired shelf location 6. Each shelf location (or space) has two parallel rows of guides, on which load 3 is transferred from transport device 2 to shelf location 6. Shelf loading or stocking track 11 can also be used as a combined load stocking and load removal track, in which case the additional load removal track 12 is not needed. Furthermore, the warehouse can be expanded on the other side of shelf stocking track 11, in which case vertical conveyor 3 will be arranged in the center of a shelf row 5.

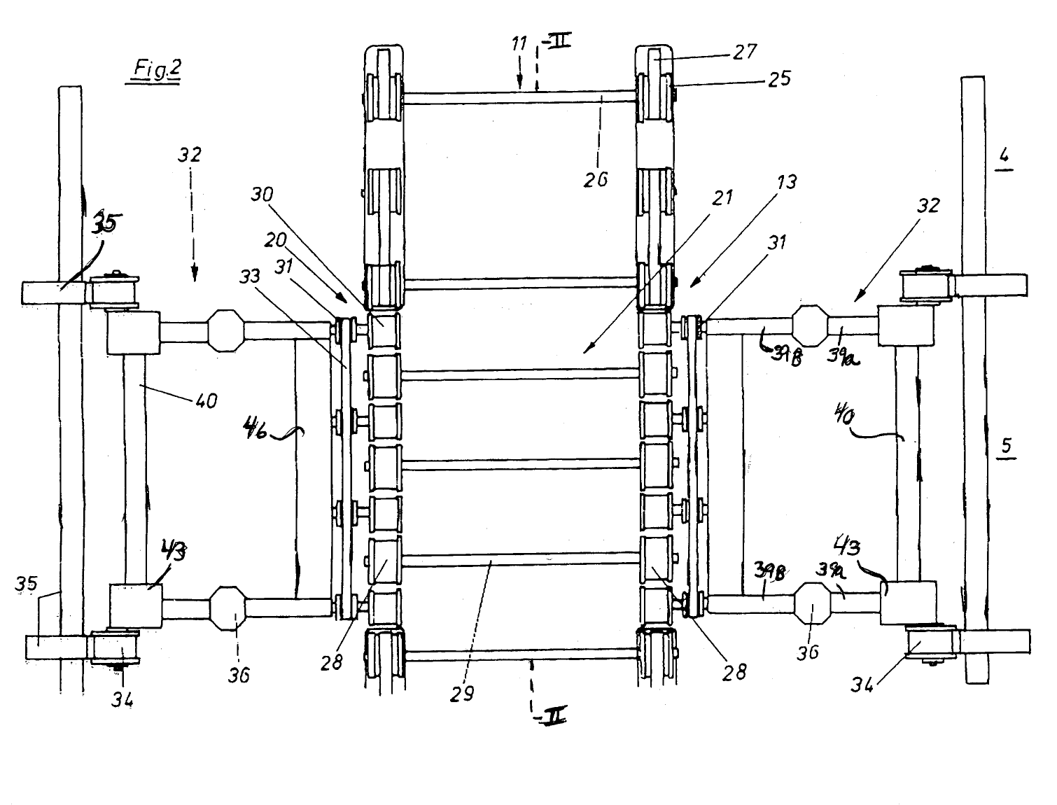

FIG. 2 shows a top view of vertical conveyor 13 located in its starting position. Vertical conveyor 13 is operated on shelf stocking track 11, which is intersected by shelf row 5 at a right angle (See FIG. 1). Vertical conveyor 13 is installed in the site of this intersection. A shelf runway 4 extends parallel with shelf row 5. Shelf stocking track 11 comprises rollers 25, which are connected to each other by belts 27 and driven. Rollers 25 form pairs of rollers that are connected with each other by axles 26. Shelf stocking track 11 is formed so that it comprises two rows of roller drives. A load 3 rests on these drives and is transported by rollers 25 or pairs of rollers along the shelf stocking track, and then arrives at vertical conveyor 13. Vertical conveyor 13 comprises vertically movable receiving devices 20 and stationary transport elements 21 which are aligned parallel to each other and spaced apart. Stationary transport elements 21 are in the form of rollers 28 as well, and connected with each other by axles 29. Rollers 28 are arranged as a continuation of the line of the shelf stocking track 11. A spacing is provided between each two of the individual rollers 20, so that an intermediate space remains available to receive receiving devices 20 wherein these receiving devices are in the form of receiving rollers 30 as well.

In the exemplified embodiment shown, three pairs of rollers 28, thus a total of six rollers 28 form the transport elements, and four pairs of rollers 30 form the receiving devices 20. Receiving devices 20 can thus be raised vertically Rollers 30 are arranged so that they alternate with each other, so that overall, a through-extending row of rollers is available in shelf stocking track 11. Rollers 30 are secured via axles 31 on conveyor element 32 and are jointly driven by a driving belt 33. Rollers 30 of receiving device 20 are arranged in each case directly adjacent each of rollers 25 of shelf stocking track 11. Rollers 30 are coupled together by a belt and driven by a driving device. Therefore, these rollers are capable of providing for continuous further transport. Each side of vertical conveyor 13 can contain a conveyor element 32 that can be displaced vertically upwards via vertical rollers 34 running on a vertical column, vertical tracks or on a lever system 35 of a warehouse equipped with shelves.

Conveyor elements 32 comprise joints 36, which allow the front section of conveyor elements 32 with receiving devices 20 to be folded away downwards. These conveyor elements 32 are formed from two parallel spaced elements or shafts 39 each comprising a first section 39a and a second section 39b with the two sections 39a and 39b being coupled together by joints 36. These parallel spaced shafts are coupled to rollers 34 via blocks 43, and wherein blocks 43 are spaced apart by support or spacer bar 40, while an opposite or second end of parallel spaced elements 39 are spaced apart and supported by support or spacer bar 46 disposed adjacent to receiving rollers 30.

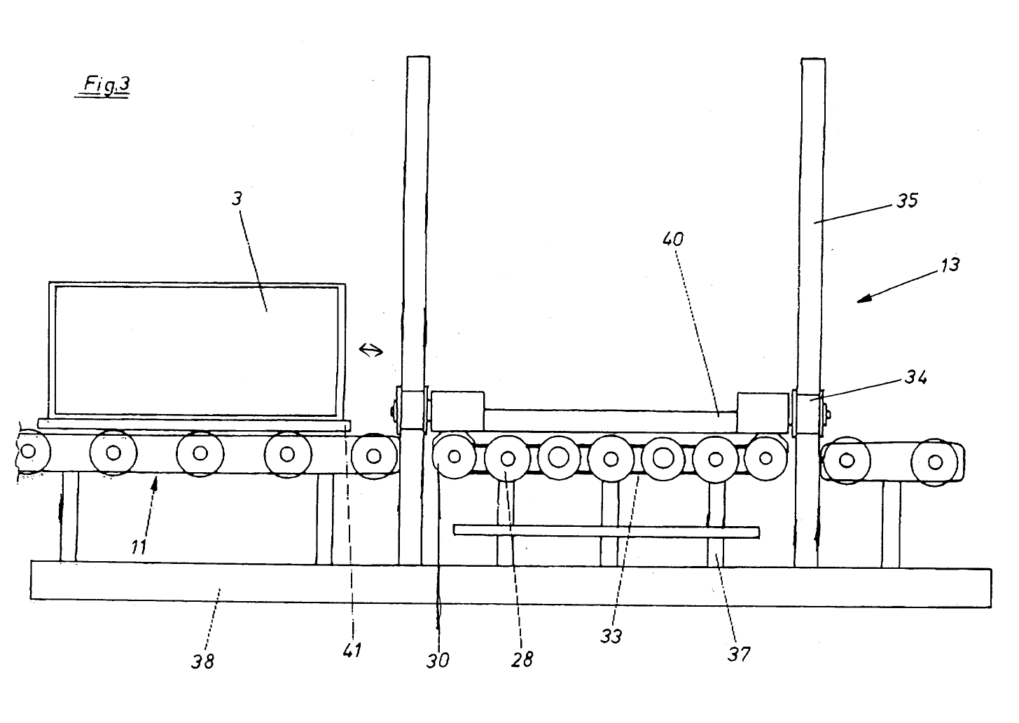

FIG. 3 shows a cut side view-along the line II-II in FIG. 2 of vertical conveyor 13. Identical elements are denoted by the same reference numerals. Rollers 28 of transport elements 21 are arranged on floor 38 of the shelf warehouse by means of vertical struts 37. A load placed on a transport pallet 41 is delivered to vertical conveyor 13 via shelf stocking track 11. In this operation, rollers 30 of receiving device 20 are first located at about the same level as rollers 28 of transport elements 21. Receiving device 20 can be lowered also below the level of transport elements 21 to make it easier to push on to transport pallet 41.

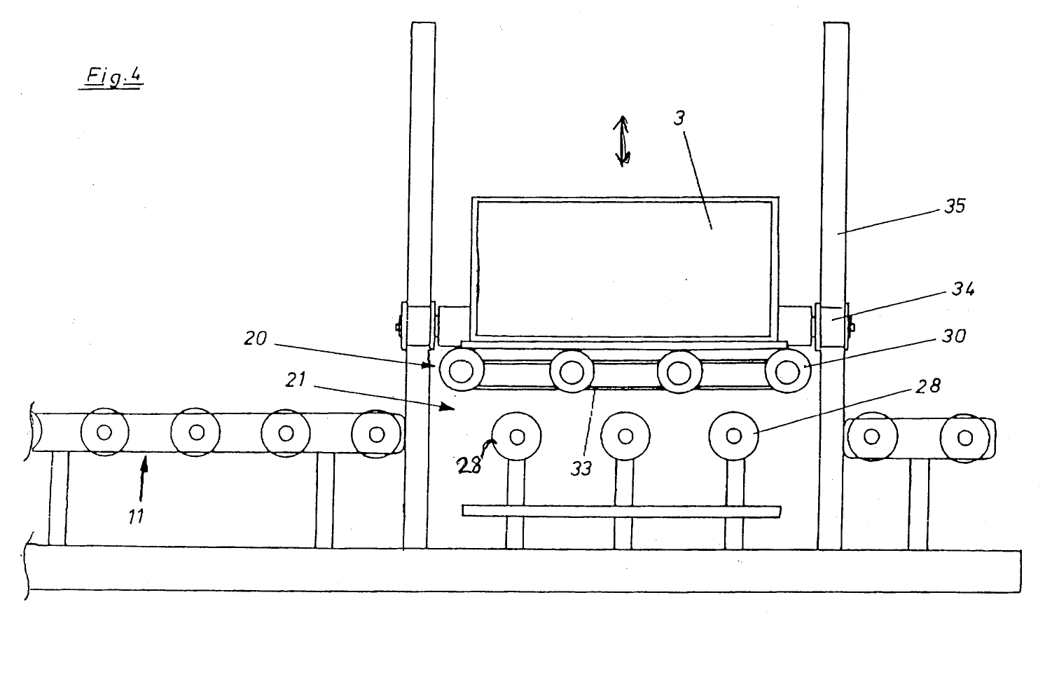

FIG. 4 is another side view of vertical conveyor 13, showing that the vertical conveyor has now raised the load 3.

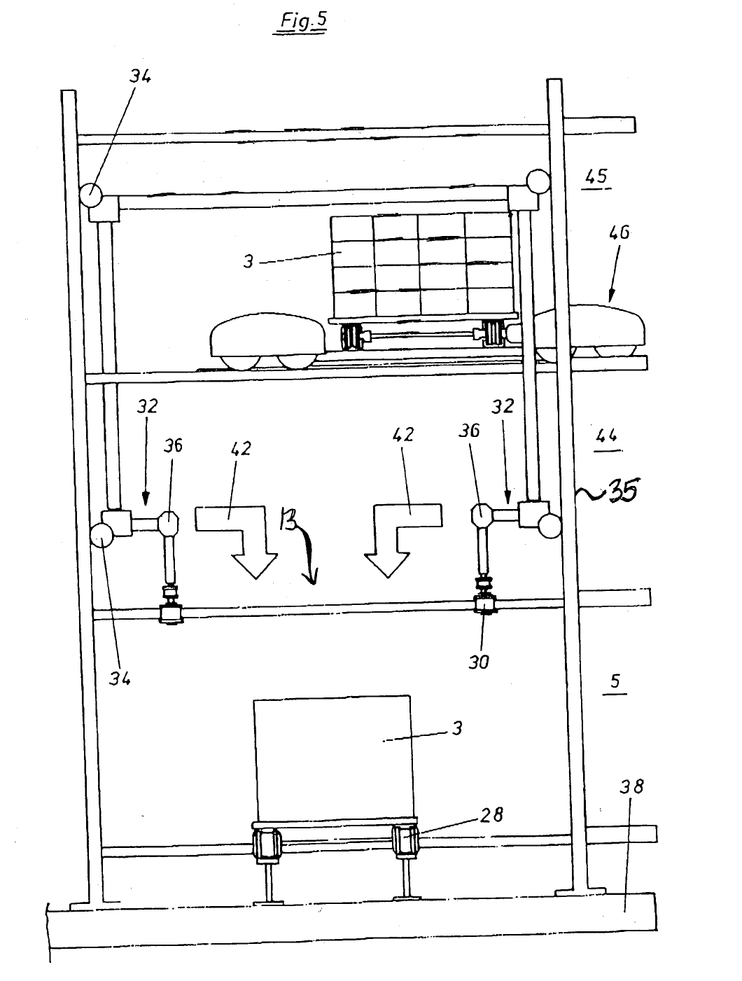

FIG. 5 shows a cut side view that has been turned by 90° versus FIGS. 3 and 4. The different levels 5, 44 and 45 of the shelf warehouse are shown, whereby vertical conveyor 13, or at least the movable part of vertical conveyor 13 has been driven up. At the upper level, a load 3 is driven next to the vertical conveyor on runway 4 located next to the vertical conveyor with the help of a transport carriage 46, and can be loaded from there on the vertical conveyor 13 as into a shelf compartment. The arrows 42 indicate that the front part of conveyor elements 32 have been folded down on via joint 36, so that the rollers 30 are in a down position. Conveyor elements 32 are folded down using joint 36 so that the area formed by the conveyor element 32 being folded down is sufficiently large to clear an inner space that is wider than load 3. Vertical conveyor 13 can be driven down, whereby the rollers 30 are first swivelled again up using joint 36 and only then take hold of the load 3 from the bottom. In this position, these loads are already waiting in the shelf-stocking position. The spacing between rollers 28 of transport elements 21 and the floor 38 of the shelf warehouse is adapted to meet the requirements for the space required by this swiveling movement of conveyor element 32.

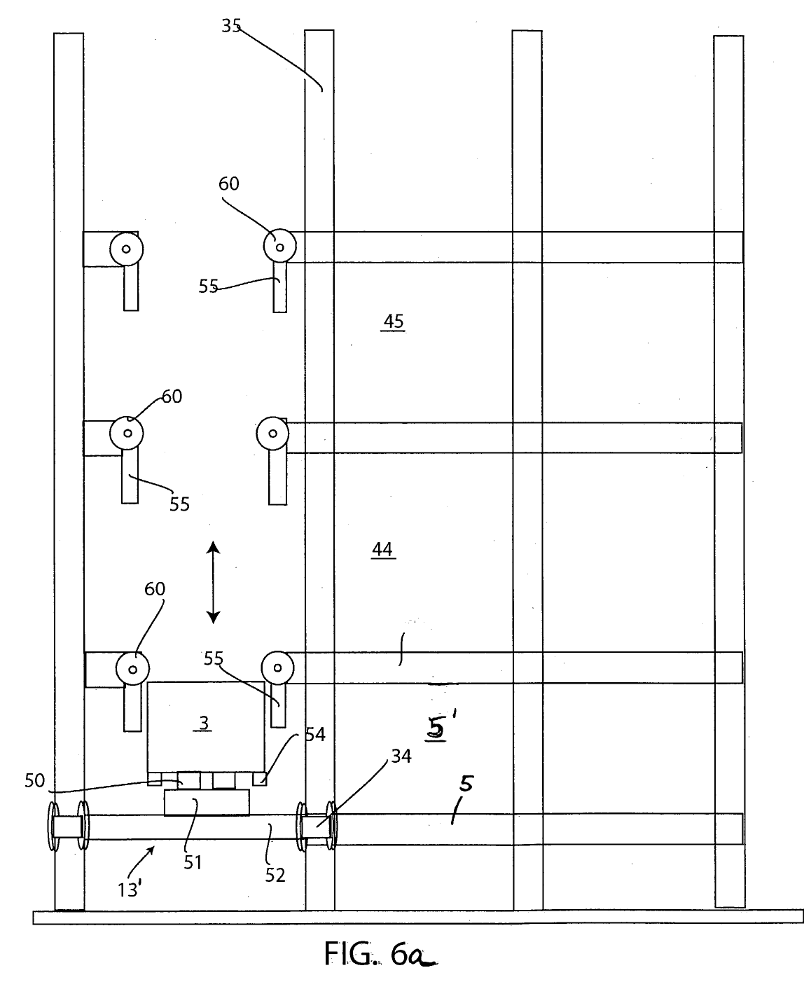

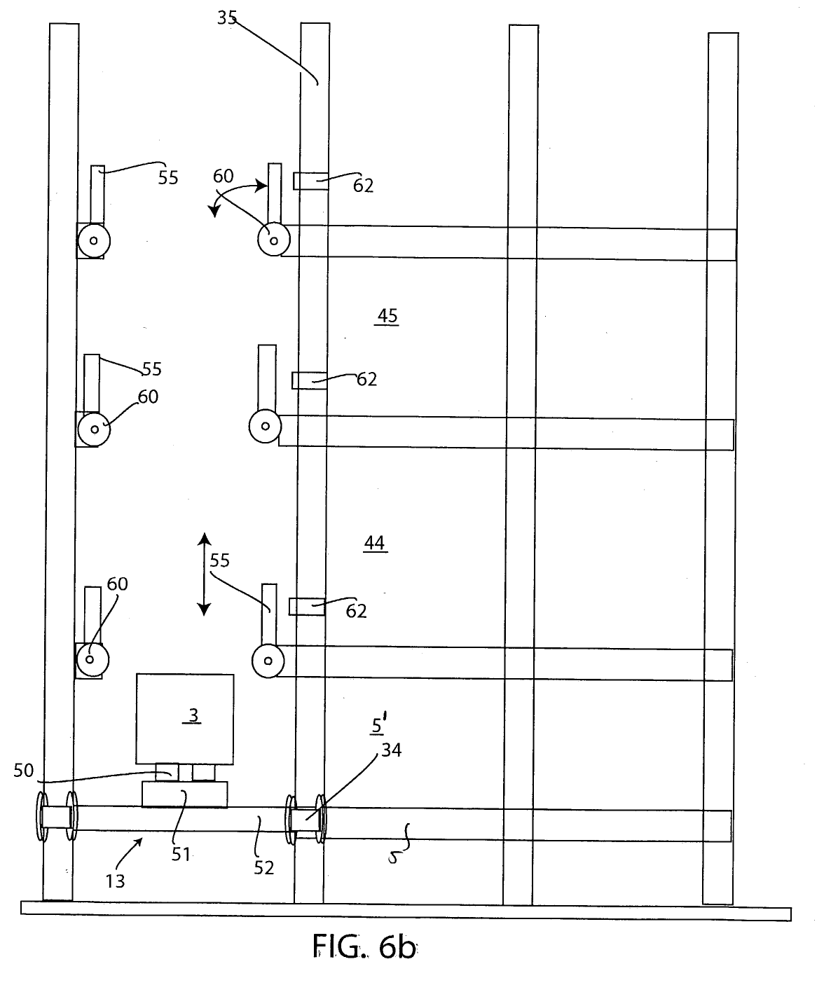

FIG. 6a shows another embodiment of the invention, which shows a vertical conveyor 13′ that is from the same view as FIG. 5. In this view, there are shown the different levels 5′, 44 and 45 formed by rows 5 and also there is shown vertical conveyor 13′ for moving a load 3 up to these different levels via a lever system or substantially vertical column or vertical track 35. The vertical conveyor can move up to these different levels via a plurality of rollers 34 rolling with vertical column or track 35. With this embodiment, vertical conveyor 13 of FIGS. 1-5 can be used or a different vertical conveyor 13′ can be used. Vertical conveyor 13′ comprises at least one shaft or beam 52 which is coupled to rollers 34 and extends between rollers 34 to form a platform. Shaft or beam 52 supports shield 51 and spacer beams 50.

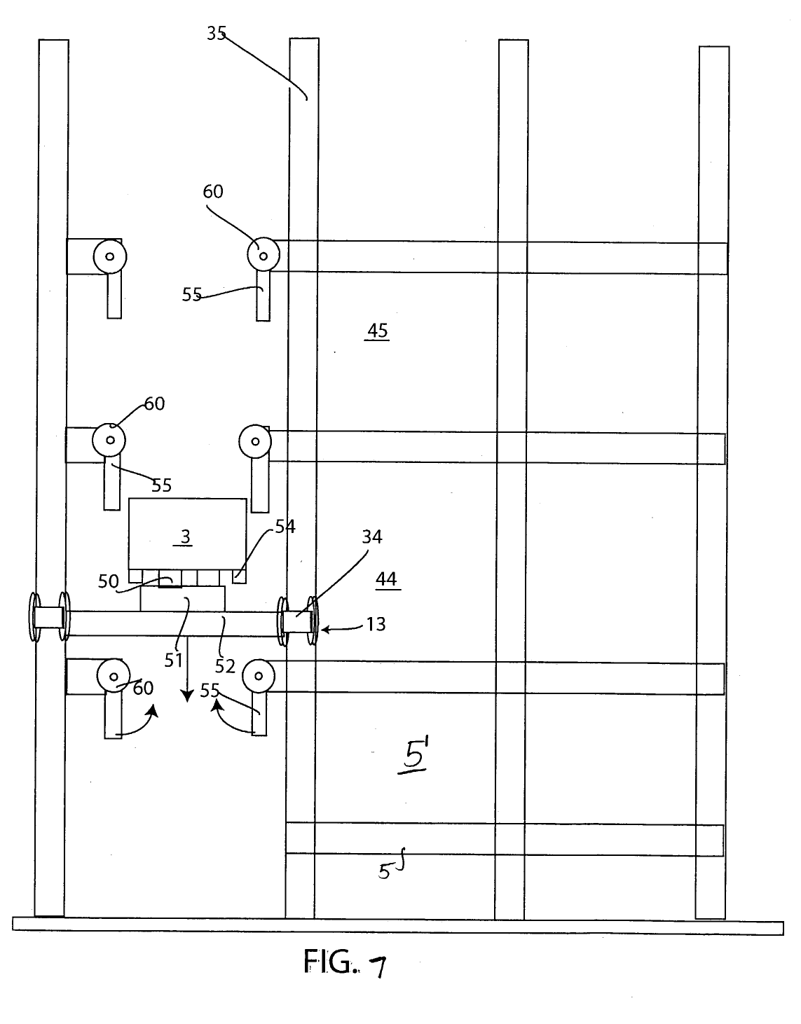

Load 3 rests on two substantially parallel spaced spacer beams 50 which are coupled to a shield 51 which rests on top of horizontal shaft 52 which is displaceable by rollers 34. On both sides of horizontal shaft 52 and disposed along lever system 35 are a plurality of foldable or displaceable elements or beams 55 which are coupled to a row 5 on each of the different levels 5′, 44, 45 via a rotating drive or joint 60. Alternatively, rotating drive or joint 60 can also be coupled to vertical track 35 in a manner to not interfere with rollers 34 rolling up and down vertical track 35. Rotating drive 60 can comprise a hinge and a motor such that when load 3 is positioned above a stocking track, foldable or displaceable elements 55 can be folded up by rotating drive 60 as shown in FIG. 7. In addition, FIG. 6b shows the another embodiment wherein foldable element 55 is foldable into an upward position to clear space in the shaft for vertical conveyor 13′. Foldable element can then be folded down into an extended or second position to receive load 3.

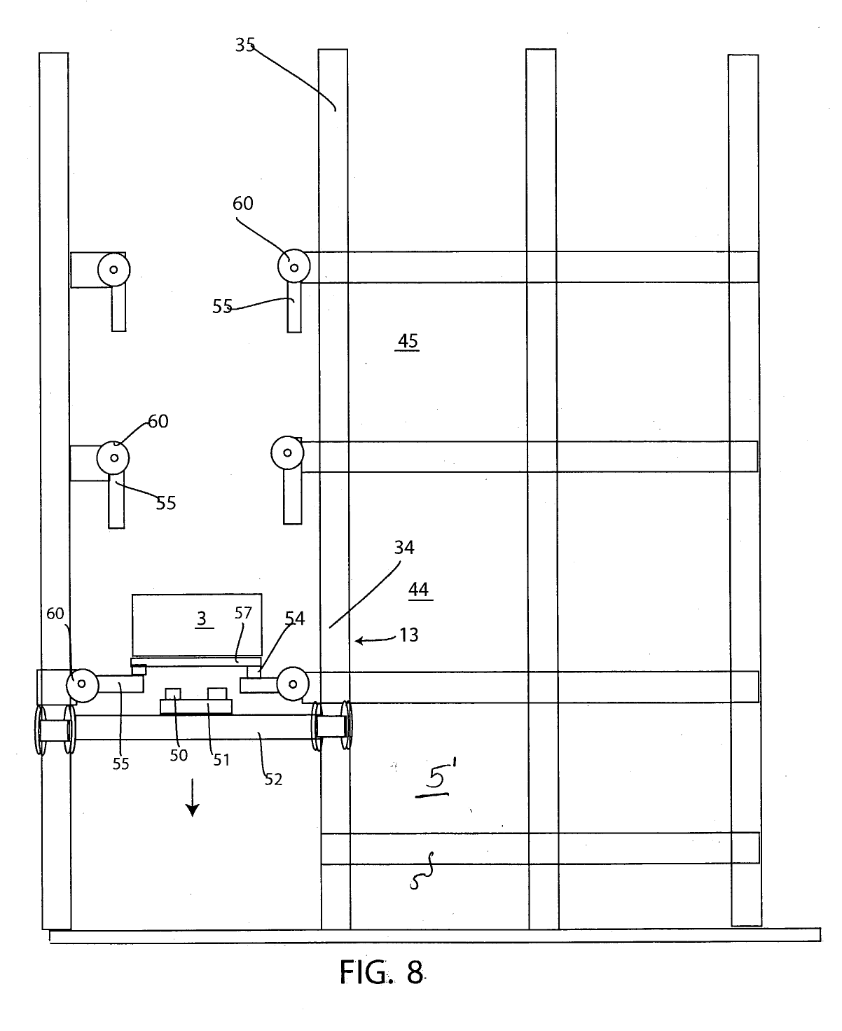

In use, vertical conveyor 13′ is driven up via rollers 34 on lever system 35 so that it is positioned just above a level for deposit. Next, rotating drives 60 coupled to two opposing foldable elements 55 rotate these foldable elements so that foldable elements 55 are positioned into a substantially horizontal position. At this point, and as shown in FIG. 8, foldable elements 55 fold underneath receiving beams or spacers 54 but do not contact shield 51 or beams 50. Instead, foldable elements 55 fold up to contact beams 54 which extend down from load 3 which help to elevate load 3 off of a vertical conveyor 13′. To determine whether to rotate foldable elements 55 into a down or up position, sensors 62 can be positioned at predetermined locations along vertical column 35. Sensors 62 are in communication with joints 60 and at least one processor (not shown) for instructing rotating drives or joints 60 to either open or close. Alternatively, rollers 34 can also contain position sensors (not shown) to determine the position of rollers 34 on vertical column 35 to then signal a processor (not shown) to instruct rotating drives or joints 60 to rotate foldable elements 55 into either an up position or a down position.

In a first embodiment, bars 54 are coupled directly to each load 3, however, in a second embodiment, as shown in FIG. 8, bars 54 are coupled to opposite ends of a plate 57 which sits below load 3 and allows load 3 to be lifted off of vertical conveyor 13′. The foldable or displaceable elements 55 situated along a vertical column or shaft, are designed to fold down to allow a vertical conveyor 13′ to move vertically in the shaft and to fold up to receive and transport a load 3 from vertical conveyor 13′. Thus this design allows for the movement of a vertical conveyor on a vertical shaft having an opening of adjustable size to accommodate vertical conveyors of a larger size.

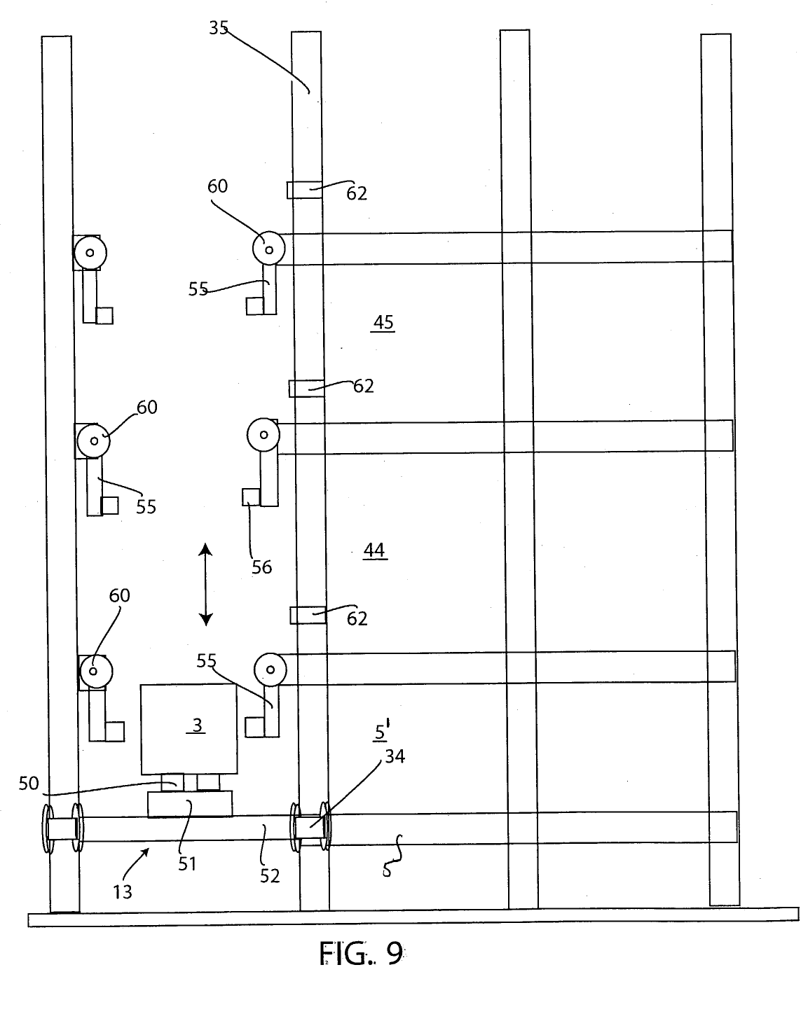

FIG. 9 shows another embodiment of foldable elements 55 wherein these foldable elements contain additional receiving or lifting protrusions 56 that can be used to lift load 3 off of vertical conveyor 13′. With this design, bars 54 are not necessary. Instead, lifting protrustions 56 contact load 3 and are used to lift load 3 off of vertical conveyor 13′ so that transport carriage 46 can then transport load 13′ along a shelf.

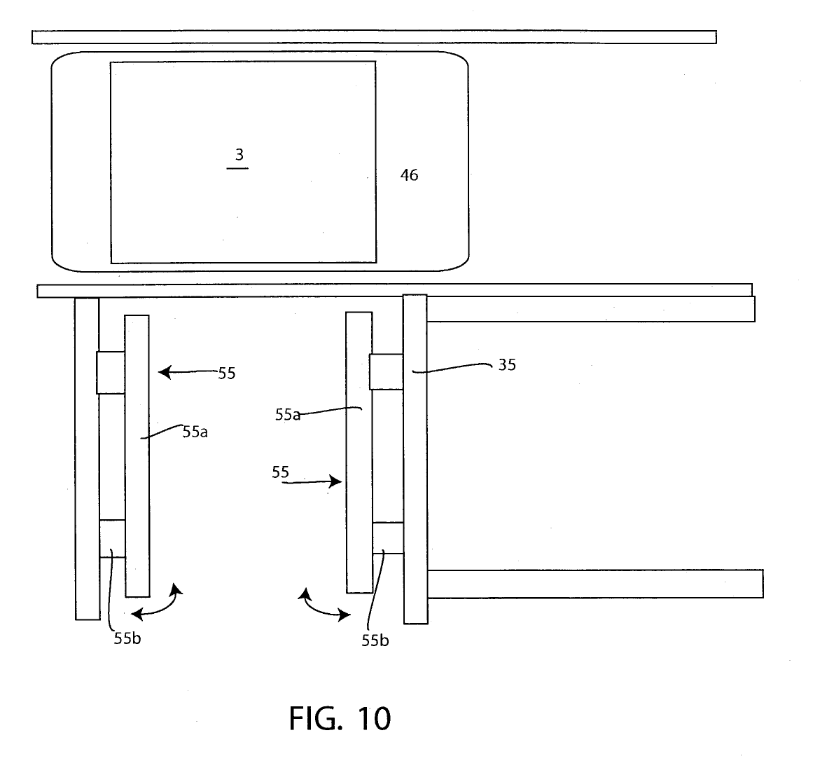

FIG. 10 is a top view of the device of FIG. 6 showing the shaft housing foldable element 55 in a down position. In this view, foldable element 55 is comprised of a receiving shaft 55a, and a pair of extension members or shafts 55b which are coupled to vertical tracks 35 via rotating drive or joint 60. In this view, load 3 is shown being transported down runways 4 wherin this load can then be charged into the shaft onto vertical conveyor 13′ (not shown) or onto foldable elements 55.

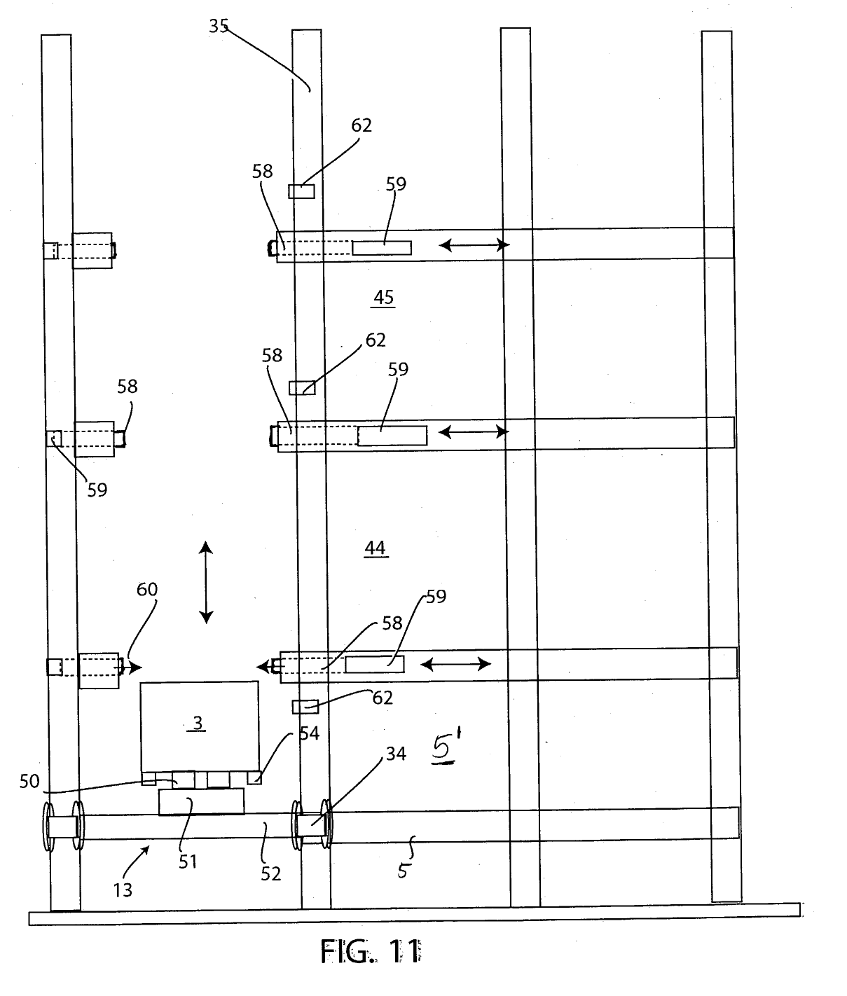

FIG. 11 shows a third embodiment of the device of FIG. 6a with a slidable element 58, being used instead of foldable element 55. Slidable element 58 can be used in a similar manner as foldable element 55. In this case, slidable element 58 can be activated by means of a sliding drive 59 which is disposed in a row 5 and which selectively drives slidable element 58 out or in to either allow slidable element 58 to open up the shaft in an inward or retracted position or to receive the load for placing on the track in an outward or extended position. Once the load is placed on slidable receiving element 58, it can be transported down rows 5 to the desired shelf location 6 via transport carriage 46.

When using the above embodiment, a vertical conveyor 13 is driven up, while slidable elements 58 are in a retracted position. When vertical conveyor 13 reaches a level for depositing a load, it triggers sensor 62 to signal slidable element 58 to slide out to receive a load. This occurs when vertical conveyor 13 is positioned above the particular level to receive the load.

Accordingly, while a few embodiments of the present invention have been shown and described, it is to be understood that many changes and modifications may be made thereunto without departing from the spirit and scope of the invention as defined in the appended claims.

What is claimed is:

1. A vertical conveyor for transporting a load in a warehouse equipped with shelves, wherein the vertical conveyor comprises:
a plurality of receiving devices spaced apart from each other wherein said plurality of receiving devices receive a load and wherein said plurality of receiving devices can be displaced vertically, and wherein each of said receiving devices comprise:
a) a plurality of parallel spaced receiving shafts wherein each receiving shaft has a first section and a second section;
b) a plurality of joints, wherein at least one joint connects said first section of said receiving shaft to said second section of said receiving shaft;
c) a plurality of rollers wherein at least one roller is coupled to an end of each of said second section of said plurality of parallel spaced receiving shafts opposite said at least one joint connecting said first section to said second section of said receiving shaft.

2. The vertical conveyor as in claim 1, wherein each of said plurality of receiving devices comprises a support element coupled to each of said plurality of parallel spaced receiving shafts, and further comprises a plurality of additional rollers coupled to said support element.

3. The vertical conveyor according to claim 1, wherein the vertical conveyor further comprises a series of stationary transport elements.

4. The vertical conveyor according to claim 3, wherein each of said series of stationary transport elements are spaced apart from each other.

5. The vertical conveyor according to claim 2, wherein said plurality of rollers and said plurality of additional rollers are spaced apart from each other to receive a plurality of stationary transport elements there between.

6. The vertical conveyor according to claim 3, wherein said plurality of receiving devices and said series of stationary transport elements are arranged in an alternating manner.

7. The vertical conveyor according to claim 3, wherein said plurality of receiving devices can be lowered below said series of stationary transport elements.

9. The vertical conveyor according to claim 3, wherein said series of stationary elements comprises driven rollers.

10. The vertical conveyor according to claim 1, wherein the vertical conveyor is arranged in a shelf warehouse in a row of shelves.

11. The vertical conveyor according to claim 1, wherein said plurality of joints on said plurality of receiving devices allow said plurality of receiving devices to be folded away.

12. A vertical conveyor system for transporting a load in a warehouse equipped with shelves defining different vertically positioned levels, wherein the vertical conveyor system comprises:
a) at least one substantially vertical track defining a shaft;
b) at least one vertical conveyor for conveying a load, wherein said vertical conveyor is vertically displacable in said shaft on said at least one substantially vertical track;
c) a plurality of foldable elements wherein at least one of said plurality of foldable elements is coupled to said at least one substantially vertical track; and
d) a plurality of joints for coupling each of said plurality of foldable elements to said at least one substantially vertical track wherein at least one of said plurality of foldable elements is positioned at a particular level in said shaft and wherein said vertical conveyor is moved vertically in said shaft from one level to another level while said plurality of foldable elements can be positioned in a first position to allow said at least one vertical conveyor to move in said shaft, and wherein at least one of said plurality of foldable elements can be positioned in a second position to allow said at least one vertical conveyor to place the load on at least one of said plurality of foldable elements.

13. The system as in claim 12, further comprising a shield disposed on a receiving space of said vertical conveyor wherein said shield is for spacing the load off of said vertical conveyor.

14. The system as in claim 13, further comprising a plurality of parallel extending spacer beams coupled to said shield wherein said plurality of extending beams are for spacing the load off of said shield.

15. The system as in claim 14, further comprising a plurality of additional extending parallel beams disposed adjacent to the load for contacting and receiving at least one of said plurality of foldable elements to allow said foldable elements to lift the load off of said vertical conveyor.

16. The system as in claim 14, wherein at least one of said plurality of foldable elements further comprise at least one lifting protrusion extending substantially perpendicular to a longitudinal axis of said foldable element to allow said foldable elements to lift the load off of said vertical conveyor.

17. A vertical conveyor system for transporting a load in a warehouse equipped with shelves, wherein the vertical conveyor system comprises:
a) a plurality of substantially vertical tracks defining a shaft;
b) at least one vertical conveyor for conveying a load, wherein said vertical conveyor is vertically displacable in said shaft;
c) a plurality of rows coupled to said at least one substantially vertical track, wherein at least two of said plurality of rows define a plurality of different vertical levels along said at least one substantially vertical track; and
d) a plurality of slidable elements wherein at least one of said plurality of slidable elements is coupled to at least one of said plurality of rows and slidable in a substantially horizontal manner wherein said plurality of slidable elements are slidable along said row and can be driven both in and out of said shaft to alternately open said shaft to allow said vertical conveyor to move vertically up or down said shaft when said plurality of slidable elements are in a retracted position, and to allow the load to be placed on said slidable elements when said slidable elements are in an extended position.

18. The system as in claim 17, further comprising a plurality of sliding drives, wherein at least one drive is coupled to at least one of said plurality of slidable elements, wherein said drive is for selectively sliding each of said plurality of slidable elements from a retracted position to an extended position.

19. The system as in claim 12, further comprising at least one sensor for detecting a position of the load in relation to a vertical position in the shaft, wherein said sensor is in communication with each of said plurality of joints to selectively signal any one of said plurality of joints whether to rotate said joint.

20. A vertical conveyor system for transporting a load in a warehouse equipped with shelves defining different vertically positioned levels, wherein the vertical conveyor system comprises:
a) at least one substantially vertical track defining a shaft;
b) at least one vertical conveyor for conveying a load, wherein said vertical conveyor is vertically displacable in said shaft on said at least one substantially vertical track;
c) a plurality of rows coupled to said at least one substantially vertical track, wherein at least two of said plurality of rows define a plurality of different vertical levels along said at least one substantially vertical track;
d) a plurality of foldable elements wherein at least one of said plurality of foldable elements is coupled to at least one of said plurality of rows;
e) a plurality of joints for coupling each of said plurality of foldable elements to said at least one of said plurality of rows and wherein at least one of said plurality of foldable elements is positioned at a particular level in said shaft and wherein said vertical conveyor is moved vertically in said shaft from one level to another level while said plurality of foldable elements can be positioned in a first position to allow said at least one vertical conveyor to move in said shaft, and wherein at least one of said plurality of foldable elements can be positioned in a second position to allow said at least one vertical conveyor to place the load on at least one of said plurality of foldable elements.
